(19) United States
(12) Patent Application Publication
(10) Pub. No.: US 2018/0045119 A1
(43) Pub. Date: Feb. 15, 2018

(54) GEARED TURBOFAN WITH LOW SPOOL POWER EXTRACTION

(71) Applicant: United Technologies Corporation, Farmington, CT (US)

(72) Inventors: William G. Sheridan, Southington, CT (US); Gabriel L. Suciu, Glastonbury, CT (US); Michael E. McCune, Colchester, CT (US)

(21) Appl. No.: 15/232,101

(22) Filed: Aug. 9, 2016

(51) Int. Cl. F02C 7/32; F02C 7/275; F02N 11/00; F02K 3/06

(52) U.S. Cl. CPC F02C 7/32; F02K 3/06; F02C 7/275; F02N 11/00; F05D 2220/327; F05D 2220/76; F05D 2260/98; F05D 2260/85

(57) ABSTRACT

A geared turbofan engine includes a first spool including a first compressor and a first turbine. The first compressor is immediately before a combustor and the first turbine is immediately after the combustor. A second spool includes at least a second turbine disposed axially aft of the first turbine. A first tower shaft is engaged to drive the high speed spool. A second tower shaft engaged to be driven by the second spool. A starter is engaged to drive the first tower shaft. An accessory gear box is driven by the second tower shaft. A first clutch is disposed between the first tower shaft and the starter. The first clutch is configured to enable the starter to drive the high speed spool. A second clutch is disposed between the second tower shaft and the accessory gear box, the second clutch configured to enable the second spool to drive the accessory gear box. A gas turbine engine and a method of operating a gas turbine engine are also disclosed.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-energy exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

The engine is typically started by driving the high spool through a tower shaft with an electric motor. Once the high spool is up to speed, the low spool follows and the engine is brought to an idle condition. When the engine is operating, the electric motor is driven through the same tower shaft to generate electric power. The tower shaft driven by the high spool may also drive an accessory gear box. The loads placed on the high spool can decrease overall engine efficiency.

Turbine engine manufacturers continue to seek further improvements to engine performance including improvements to thermal, transfer and propulsive efficiencies.

### SUMMARY

In a featured embodiment, a geared turbofan engine includes a first spool including a first compressor and a first turbine. The first compressor is immediately before a combustor and the first turbine is immediately after the combustor. A second spool includes at least a second turbine disposed axially aft of the first turbine. A first tower shaft is engaged to drive the high speed spool. A second tower shaft engaged to be driven by the second spool. A starter is engaged to drive the first tower shaft. An accessory gear box is driven by the second tower shaft. A first clutch is disposed between the first tower shaft and the starter. The first clutch is configured to enable the starter to drive the high speed spool. A second clutch is disposed between the second tower shaft and the accessory gear box, the second clutch configured to enable the second spool to drive the accessory gear box.

In another embodiment according to the previous embodiment, includes a fan driven by a speed reduction device. The speed reduction device is driven by the second spool.

In another embodiment according to any of the previous embodiments, includes a windmill oil system configured to supply lubricant to the speed reduction device responsive to windmilling of the fan.

In another embodiment according to any of the previous embodiments, the second spool includes a second compressor axially forward of the first compressor. The second compressor includes an operating pressure less than that of the first compressor.

In another embodiment according to any of the previous embodiments, the starter includes a starter/generator operable to drive the first tower shaft and be driven by the second tower shaft.

In another embodiment according to any of the previous embodiments, the starter generator is driven through a gear set of the accessory gearbox.

In another embodiment according to any of the previous embodiments, the accessory gearbox includes at least one mechanical pump.

In another embodiment according to any of the previous embodiments, the first clutch and the second clutch are one-way mechanical clutch devices.

In another featured embodiment, a gas turbine engine includes a fan including a plurality of fan blades rotatable about an axis. A compressor section includes a first compressor. A combustor is in fluid communication with the first compressor. A turbine section is in fluid communication with the combustor. The turbine section includes a first turbine and a second turbine. A geared architecture is driven by the second turbine for rotating the fan about the axis. A first shaft couples the first turbine to the first compressor. A second shaft couples the second turbine to the geared architecture. A first tower shaft is coupled to the first shaft. A second tower shaft is coupled to the second shaft. An accessory gear box includes gear system for driving at least one accessory component. The gear system is coupled to both the first tower shaft and the second tower shaft. A starter generator is coupled to the gear system. A first clutch is configured to control torque transfer between the starter and the first tower shaft. The first clutch enables the starter to drive the first shaft through the first tower shaft. A second clutch is configured to control torque transfer between the second tower shaft and the accessory gearbox. The second clutch enables the second shaft to drive the second tower shaft.

In another embodiment according to the previous embodiment, the first clutch is configured to disengage torque transfer from the first shaft to the starter generator.

In another embodiment according to any of the previous embodiments, the second clutch is configured to disengage torque transfer from the gear system to the second shaft.

In another embodiment according to any of the previous embodiments, includes a windmill oil system configured to supply lubricant to the geared architecture responsive to rotation of the fan without the engine operating.

In another embodiment according to any of the previous embodiments, the accessory gearbox includes at least one mechanical pump.

In another featured embodiment, a method operating a gas turbine engine includes driving a first spool with a starter through a first tower shaft and a first clutch to start the engine. An accessory gear box drives through a second clutch with a second tower shaft coupled to a second spool once the engine is started. The starter is decoupled from the first spool once the first spool reaches an engine idle speed.

In another embodiment according to the previous embodiment, driving the accessory gear box includes driving a generator through the accessory gear box.

In another embodiment according to any of the previous embodiments, decoupling the first clutch includes rotating the second tower shaft at a speed greater than that of the starter.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a schematic view of an example accessory gear box embodiment.

FIG. 3 is a schematic view of the example accessory gear box and tower shafts.

FIG. 4 is a schematic view of accessory gear box operation during a starting process.

FIG. 5 is a schematic view of accessory gear box operation during engine operation.

### DETAILED DESCRIPTION

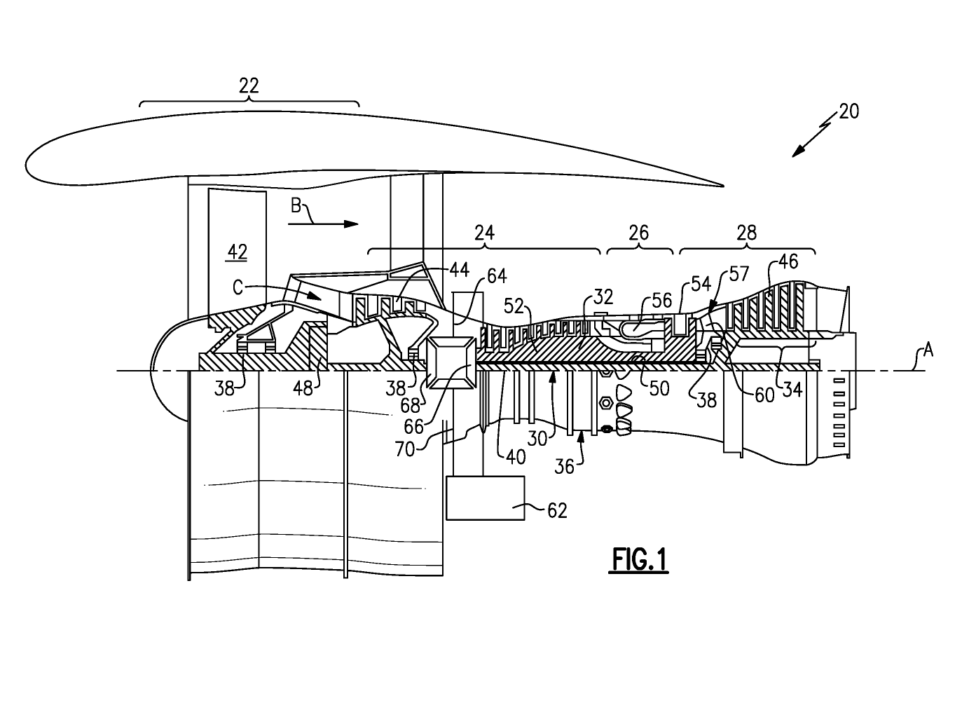

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 58 of the engine static structure 36 is arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10.67 km). The flight condition of 0.8 Mach and 35,000 ft (10.67 km), with the engine at its best fuel consumption —also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]0.5. The “Low corrected fan tip speed” as disclosed herein according to one non-limiting embodiment is less than about 1150 ft/second (350 m/second).

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

The example engine 20 includes a first tower shaft 64 that is engaged to drive the high speed spool 32. The engine 20 further includes a second tower shaft 66 that is engaged to be driven by the low speed spool 30. The low speed spool 30 includes a gear 70 and the high speed spool 32 includes a gear 68. The gear 68 is engaged to the tower shaft 64 and the gear 70 is engaged to the tower shaft 66. Each of the tower shafts 64 and 66 drive portions of an accessory gearbox 62. In one disclosed embodiment the gears 68 and 70 are bevel gears and engage corresponding bevel gears on the corresponding tower shaft 64, 66.

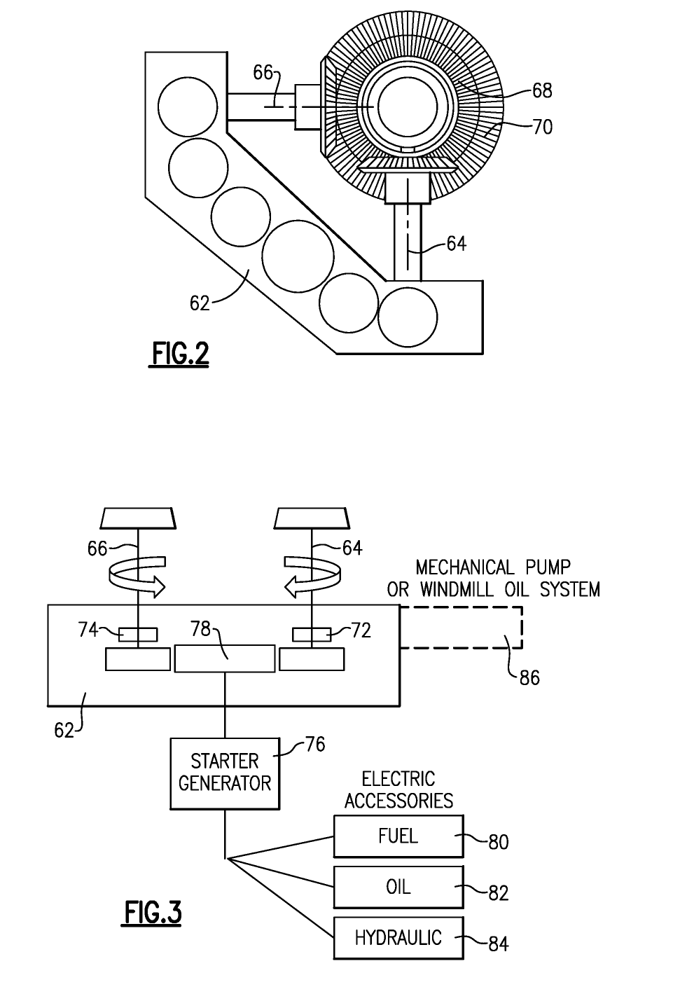

Referring to FIG. 2 with continued reference to FIG. 1, the example gearbox 62 includes a gear engagement with both the first tower shaft 64 and the second tower shaft 66. The tower shafts 64, 66 are supported within a common accessory gearbox 62 and enable the use of the low speed spool 30 to drive the accessory components within the accessory gearbox 62.

As the core components of the engine 20 become more efficient, larger fans will be utilized and smaller core components such as the high speed spool 30 will become smaller and more efficient. As the core engine components such as the high speed. As the high speed spool 32 components become smaller, the drag caused by the loads that accompany driving the accessory gearbox can alter compressor surge margins and other performance characteristics that detract from the overall engine deficiency.

Starting of an engine requires driving of the high speed spool up to an starting or engine idle speed and therefore a tower shaft is provided to drive the high speed spool. Because the tower shaft is already provided for starting purposes, it was traditionally more expedient to drive the accessory components through the same tower shaft. Accordingly, prior engines included a single tower shaft that was utilized both to drive the high speed spool during starting operations and then to have the high speed spool drive the accessory components while the engine was operating. However, as efficiencies are gained that enable the high speed spool to become smaller, it becomes less desirable to drive the accessory components with the high speed spool.

Accordingly, the example gas turbine engine includes the second tower shaft 66 that is driven by the low speed spool 30 and utilized to drive the accessory components.

Referring to FIG. 3 with continued reference to FIG. 2, the example gearbox 62 includes a first clutch 72 that is engaged to the first tower shaft 64 coupled to the high speed spool 32. A second clutch 74 is disposed on the second tower shaft 66 driven by the low speed spool 30. Each of the clutches 74 and 72 provide for the transmission of torque in a single direction. The accessory gearbox 62 is engaged to a starter generator 76 that drives a gear 78 that meshes to drive both the first tower shaft 64 and the second tower shaft 66. The starter/generator 76 can be driven to provide electrical power to electric accessories including a fuel pump 80, oil pump 82 and a hydraulic pump 84. The accessory gearbox 62 may also be geared and include power takeoff gearing to provide driving force for mechanical systems or mechanical pumps.

In the disclosed example, the clutches 72 and 74 are sprag clutches that only allow torque to be transmitted in one direction. When torque is reversed meaning that the driving member becomes the driven member, the clutch will slip and allows the shaft to over speed and rotate independent of the gearbox 62. In this example, the second clutch 74 will allow the low rotor to drive the gearbox 62 and the starter/generator 76 but does not allow the gearbox 62 to drive low speed spool 30. In this example, the clutch 74 is located within the accessory gearbox 62, however, the clutch 74 may be located wherever practical to provide the selective application of torque between the starter/generator, accessory gearbox 62 and the low speed spool 30.

The clutch 72 is configured to allow the starter/generators 76 to drive the high speed spool 32 but not to allow the high speed spool 32 to drive the gearbox 62. In this example, because the high speed spool 32 will rotate much faster than the starter/generator 76, the clutch 72 is configured such that the high speed spool 32 may over speed past the speed of the starter/generator 76 and not transmit torque to the accessory gearbox 62 through the tower shaft 64.

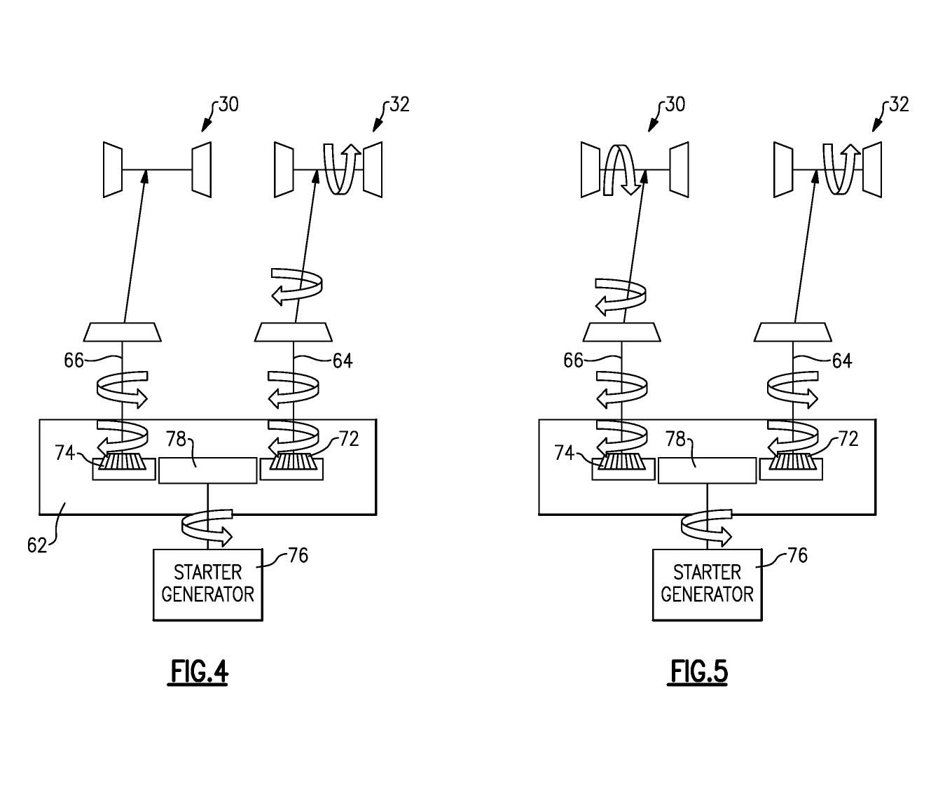

Referring to FIG. 4, the example accessory gearbox 62 is shown during an engine starting operation. In this schematic illustration, the starter/generator 76 is shown driving gear 78 within the accessory gearbox 62 that in turn drives the clutch 72 and thereby the tower shaft 64 to drive the high speed spool 30 up to a speed required for starting of the engine. The same gear 78 driven by the starter/generator is also driving the second clutch 74 that is engaged to the second tower shaft 66 driven by the low speed spool 30. However, in this instance, the clutch 74 is not transmitting torque to the low speed spool 30. Accordingly, in the configuration schematically illustrated in FIG. 4, only the high spool 32 is turning.

Once the high speed spool 30 has been spun up to operating conditions, it will attain a speed that is much greater than that input by the starter/generator 76 and the tower shaft 64. The tower shaft 64 will continue to rotate in a direction originally provided by the starter/generator 76, however, the high speed spool driven tower shaft 64 is rotating at a much higher speed and therefore spin past the speed input by the starter/generator 76. The clutch 72 will not allow the transmission of this higher torque from the high speed spool 32 into the accessory gearbox 62.

Once the high speed spool 32 has become operational, the low speed spool 30 will also begin to turn. Rotation of the high speed spool will result in turning of the second tower shaft 66. The second tower shaft 66 will in turn, turn the gear 78 through the clutch 74 which will drive the starter/generator 76. Because the one way clutch 74 is orientated and configured to enable the low speed spool 30 to drive the tower shaft 74 and in turn drive the starter/generator 76, the accessory components engaged to the gearbox 62 along with the starter/generator 76 are turned and operated by the low speed spool 30.

Accordingly, once the engine is running, the starter/generator 76 may produce electric power to drive any number of accessory units, such as the fuel pump 80, hydraulic pump 84 and/or oil pump 82 as illustrated in FIG. 3. Moreover, once the engine is operational, the accessory components no matter if they are electrically powered or mechanically powered are driven by the low speed spool 30.

The accessory gearbox 62 may also mechanically drive a pump system for a windmill lubricant system as shown schematically at 86 in FIG. 3. A windmill lubricant system 86 provides lubricant flow to the geared architecture when the fan is rotating due to wind and airflow without the engine operating. If the engine is not running and the fan is running, the geared architecture still requires lubricant flow and therefore the example windmill lubricant system provides lubricant flow in the absence of engine operation. The example windmill lubricant system is configured to provide lubricant flow regardless of the direction that the fan is turning.

Accordingly, the example accessory gearbox enables the use of compact high speed spool systems to maximize overall engine efficiencies.

Although an example embodiment has been disclosed, a worker of ordinary skill in this art would recognize that certain modifications would come within the scope of this disclosure. For that reason, the following claims should be studied to determine the scope and content of this disclosure.

1. A geared turbofan engine comprising:
a first spool including a first compressor and a first turbine, wherein the first compressor is immediately before a combustor and the first turbine is immediately after the combustor;
a second spool including at least a second turbine disposed axially aft of the first turbine;
a first tower shaft engaged to drive the first spool;
a second tower shaft engaged to be driven by the second spool;
an accessory gear box coupled to both the first tower shaft and the second tower shaft;
a starter engaged to drive the accessory gear box;
a first clutch disposed between the first tower shaft and the accessory gear box, the first clutch configured to enable the starter to drive the first spool through the accessory gear box, wherein the first clutch is a one-way mechanical clutch capable of transmitting torque only from the accessory gear box to the first tower shaft; and
a second clutch disposed between the second tower shaft and the accessory gear box, the second clutch configured to enable the second spool to drive the accessory gear box, wherein the second clutch is a one-way mechanical clutch capable of transmitting torque only from the second tower shaft to the accessory gear box.

2. The geared turbofan engine as recited in claim 1, including a fan driven by a speed reduction device, wherein the speed reduction device is driven by the second spool.

3. The geared turbofan engine as recited in claim 2, including a windmill oil system configured to supply lubricant to the speed reduction device responsive to windmilling of the fan.

4. The geared turbofan engine as recited in claim 2, wherein the second spool includes a second compressor axially forward of the first compressor, the second compressor including an operating pressure less than that of the first compressor.

5. The geared turbofan engine as recited in claim 1, wherein the starter comprises a starter/generator operable to drive the first tower shaft and be driven by the second tower shaft.

6. The geared turbofan engine as recited in claim 5, wherein the starter generator is driven through a gear set of the accessory gearbox.

7. The geared turbofan engine as recited in claim 1, wherein the accessory gearbox includes at least one mechanical pump.

8. (canceled)

9. A gas turbine engine comprising:
a fan including a plurality of fan blades rotatable about an axis;
a compressor section including a first compressor;
a combustor in fluid communication with the first compressor, the first compressor immediately before the combustor;
a turbine section in fluid communication with the combustor, the turbine section including a first turbine and a second turbine, the first turbine immediately after the combustor;
a geared architecture forward of compressor section and coupled to be driven by the second turbine for rotating the fan about the axis;
a first shaft coupling the first turbine to the first compressor;
a second shaft coupling the second turbine to the geared architecture;
a first tower shaft coupled to the first shaft;
a second tower shaft coupled to the second shaft;
an accessory gear box including a gear system for driving at least one accessory component, the gear system coupled to both the first tower shaft and the second tower shaft;
a starter generator coupled to the gear system;
a first clutch configured to transfer torque in one direction from the gear system to the first tower shaft and disengage torque transfer from the first tower shaft to the accessory gear box, wherein the first clutch enables the starter generator to drive the first shaft through the first tower shaft; and
a second clutch configured to transfer torque in one direction from the second tower shaft to the gear system and to disengage torque transfer from the accessory gear box to the second tower shaft, wherein the second clutch enables the second shaft to drive the starter generator through the second tower shaft.

10-11. (canceled)

12. The gas turbine engine as recited in claim 9, including a windmill oil system configured to supply lubricant to the geared architecture responsive to rotation of the fan without the engine operating.

13. The gas turbine engine as recited in claim 9, wherein the accessory gearbox includes at least one mechanical pump.

14. A method operating a gas turbine engine comprising:
driving a first spool with a starter through an accessory gear box and a first tower shaft and a first one-way mechanical clutch to start the engine, wherein the first one-way mechanical clutch is configured enable transfer of torque from the starter through the accessory gear box to the first tower shaft and configured to decouple torque transfer from the first tower shaft to the accessory gear box;
driving the accessory gear box through a second one-way mechanical clutch with a second tower shaft coupled to a second spool once the engine is started, wherein the second one-way mechanical clutch is configured to enable torque transfer from the second tower shaft to the accessory gear box and disable torque transfer from the accessory gear box to the second tower shaft; and
decoupling the accessory gear box from the first spool once the first spool reaches an engine idle speed.

15. (canceled)

16. The method as recited in claim 14, including decoupling the first clutch by rotating the second tower shaft at a speed greater than that of the starter.
